(19) United States
(12) Patent Application Publication
(10) Pub. No.: US 2002/0090581 A1
(43) Pub. Date: Jul. 11, 2002

(54) Photographic bleach composition and process

(75) Inventors: Peter J. Twist, Lee Common Great Missenden (GB); John R. Fyson, Hackney (GB)

Correspondence Address: Paul A. Leipold, Patent Legal Staff, 343 State Street, Rochester, NY, 14650-2201, US

(73) Assignee: Eastman Kodak Company

(21) Appl. No.: 09/970,238

(22) Filed: Oct. 3, 2001

(30) Foreign Application Priority Data
Nov. 3, 2000 (GB) 0026956.3

(51) Int. Cl. G03C 5/44; G03C 5/38

(52) U.S. Cl. 430/427; 430/430; 430/461; 430/428

(57) ABSTRACT

An aqueous photographic bleach solution comprises, as primary oxidant, in a concentration eg from about 0.1 to about 1 Molar of a transition metal oxidizing agent and, as secondary oxidant, from about 0.03 to about 0.15 Molar of a persulphate or from about 0.1 to about 0.8 Molar of a peroxide. The primary oxidant is preferably a ferric complex of an aminopolycarboxylic acid such as ethylene diamine tetraacetic acid (EDTA), propylene diamine tetraacetic acid (PDTA), diethylene triamine pentaacetic acid (DTPA), or a substituted imino diacetic acid such as methyl imino diacetic acid (MIDA). The peroxide can be provided by a compound that liberates peroxide under the bleach conditions. The solutions of the invention are particularly suitable for use with a single use surface application device in which a small volume of the solution is used once and then discarded.

### FIELD OF THE INVENTION

This invention relates to a high speed photographic bleach composition and a process in which it is used.

### BACKGROUND OF THE INVENTION

The processing of silver halide photographic materials for example silver halide colour negative elements includes a desilvering step where silver which has been produced in the developing step is oxidized with an oxidizing agent, usually called a bleach, and dissolved away with a silver ion complexing agent, usually called a fixing agent.

### PROBLEM TO BE SOLVED BY THE INVENTION

Bleaching agents which have been previously described include compounds of polyvalent metal such as iron(III), cobalt(III), chromium(IV) and copper(II) peracids, quinones and nitro compounds. Typical bleaching agents are iron(III) salts such as ferrric chloride, ferricyanides, bichromates, and organic complexes such as aminopolycarboxylate complexes of iron(III) and cobalt(III).

However generally these bleaching agents are either too weak for rapid bleaching or are potentially harmful to the environment.

One method of enhancing the bleaching ability of color light sensitive elements is the use of bleach accelerating agents either incorporated in the elements or contained in the processing solutions. This method is not always satisfactory in that the accelerator may not provide adequate bleaching, may interfere with fixing or may require undesirable processing conditions such as high concentrations of accelerator, long processing times or high processing temperatures.

There is a continuing need for faster processing of photographic materials and reducing the time of the bleaching step enables the overall processing time to be reduced.

U.S. Pat. No. 5,318,880 describes a process for the rapid bleaching of silver halide colour negative photographic elements employing a peracid bleach and an accelerator which accelerates peracid bleaches. Examples of accelerators are sulphur containing compounds such as dimethylaminoethanethiol, dimethylaminoethanethiol isothiouronium salt, aminoethanethiol and morpholinoethanethiol.

Japanese Patent Application No 2173637A discloses a bleaching process in which a developed silver halide photographic material is treated sequentially with two bleach solutions. The first contains an iron aminopolycarboxylate and a water soluble halide salt. The second contains the same as the first but in addition a water soluble bromic acid salt is added a pH controller.

Japanese Patent Application No 79018140 describes bleaching a developed photographic material with an ammonium, potassium or sodium persulphate before or after bleaching with EDTA. The former is said to supplement the oxidizing power of the EDTA.

The present invention provides a very fast bleaching solution in which a transition metal oxidant such as a ferric aminopolycarboxylate is employed in the same solution together with a persulphate or peroxide.

### SUMMARY OF THE INVENTION

According to the present invention there is provided an aqueous photographic bleach solution comprising,

as primary oxidant, a transition metal oxidizing agent in a concentration of at least about 0.1 Molar and,

as secondary oxidant, a persulphate in a concentration of at least about 0.03 Molar or peroxide in a concentration of at least about 0.1 Molar.

### ADVANTAGEOUS EFFECT OF THE INVENTION

The advantage of the combination of transition metal oxidant and secondary oxidant is that the rate of bleaching is significantly increased. It has been found that the rate of bleaching is greater than would be predicted from the bleaching rates of the transition metal and persulphate or peroxide used alone. The combination can fairly be said to be synergistic.

### BRIEF DESCRIPTION OF THE DRAWINGS

FIGS. 1 to 11 are graphs representing sensitometric comparisons for the red, green and blue layers bleached according to different procedures.

FIG. 12a is a schematic view of part of a processing apparatus showing the use of an applicator member for applying processing solution to a photographic material;

FIG. 12b is a schematic view showing a different method of moving the applicator member into and out of contact with the material;

FIGS. 13A and 13B show a schematic side view and section view, respectively, of apparatus in which the method of the present invention can be performed.

FIG. 14 is an enlarged view of the lower portion of the embodiment shown in FIGS. 13A and 13B.

### DETAILED DESCRIPTION OF THE INVENTION

The photographic elements which are bleached by the use of the present invention can be any photographic element whether film or paper where there is a need to remove silver after development of the image. The elements may be single color elements or multicolor elements. Multicolor elements typically contain dye-forming units sensitive to each of the three primary regions of the visible spectrum. Each unit can be comprised of a single emulsion layer or of multiple emulsion layers sensitive to a given region of the spectrum. The layers of the elements, including the layers of the image-forming units, can be arranged in various orders as is known in the art. In an alternative format, the emulsions sensitive to each of the three primary regions of the spectrum can be disposed as a single segmented layer eg as by the use of microvessels as described in U.S. Pat. No. 4,362,806. The element can contain additional layers such as filter layers, interlayers, overcoat layers, subbing layers and the like.

The exposed photographic elements can be processed by any conventional technique to produce silver by development of incorporated silver halide having dye absorbed on its surface. The silver may have been generated imagewise while concurrently producing a dye image, and the silver is thereafter removed by bleaching by the present invention while leaving the dye image. Typically, a separate pH lowering solution, referred to as a stop bath, is employed to terminate development prior to bleaching.

By primary oxidant we mean an oxidant which is capable of bleaching when used as the only bleach oxidant.

By secondary oxidant we mean an oxidant which is either inactive when used alone or is of lower activity that the primary oxidant.

The transition metal oxidant used as the primary oxidant is a metal capable of existing in more than one oxidation state and when in a higher oxidation state is capable of oxidizing metallic silver to ionic silver.

Preferably the primary oxidant is a ferric complex of an aminopolycarboxylic acid for example ethylene diamine tetraacetic acid (EDTA), propylene diamine tetraacetic acid (PDTA), diethylene triamine pentaacetic acid (DTPA), or a substituted imino diacetic acid such as methyl imino diacetic acid (MIDA).

The peroxide used as the secondary oxidant in the present invention may be provided by a compound that liberates peroxide under the bleach conditions. Typical examples are perborate, percarbonate and perphosphate. Persulphate is also sometimes considered to be a source of peroxide. However the formation or peroxide is usually very slow and for this reason persulphate is not referred to in the present specification as a source of peroxide.

Typical persulphate and peroxide bleaches useful in the present invention include hydrogen, alkali, and alkaline earth salts of persulphate, peroxide, perborate, and percarbonate, and the related perhalogen bleaches such as hydrogen, alkali and alkaline earth salts of chlorate, bromate, iodate, perchlorate, perbromate and metaperiodate

Examples of formulations using these agents are described in Research Disclosure December 1989 Item 308119 Published by Kenneth Mason Publications Ltd Dudley House 12 North Street, Emsworth, Hampshire England.

Especially preferred are persulphates particularly sodium, potassium and ammonium persulphate.

The concentrations of transition metal oxidant, persulphate or peroxide in the bleach solution are conveniently up to about 1Molar, 0.15Molar and 0.8Molar respectively.

When the secondary oxidant is provided by persulphate it is preferred that the concentration is at least 0.04Molar.

When the secondary oxidant is provided by peroxide, the amount of peroxide in the bleach solution is preferably at least equivalent to that provided by 30 ml/liter of hydrogen peroxide as 30% by weight solution.

Water is employed as the solvent for the bleaching solution. The pH of the bleaching solution is maintained on the acid side of neutrality within conventional ranges, typically in the range from about 1 to about 7, preferably from about 1.5 to about 5 and more preferably from about 2 to about 4.

The bleaching solution preferably contains a buffer consisting of an organic acid or inorganic acid or salt thereof Examples include phosphoric acid, and phosphate salts, citric acid and citrate salts, boric acid and borate and metaborate salts, acetic acid and acetate salts.

The bleaching solution preferably includes an effective amount of a rehalogenating agent for example a water soluble chloride or bromide such as ammonium bromide.

To impart fixing properties to the bleaching solution thereby converting it to a bleach fix solution, it is necessary to add a silver halide solvent. Where a separate fixing bath is employed the fixing bath can take any conventional form.

According to another aspect of the present invention there is provided a photographic bleaching process which process comprises bleaching a silver halide photographic element which has been exposed and developed by contacting said exposed and developed photographic element with a bleach solution as hereinbefore defined.

In one embodiment of the process the processing solution is added by means of a surface application device. The device which is employed for the development and fixing stages as well as the bleaching stage does not have a standing tank of processing solution and the volumes of processing solution applied are similar to the volumes used to replenish standing tanks of processing solution. These volumes are small eg 2 to 4 ml/linear foot of 35 mm film and are discarded after the process stage is complete. A suitable device is described in our copending UK Patent Application No. 9930140.0 filed Dec. 22, 1999 which describes an apparatus for processing light sensitive material, the apparatus comprising at least one movable applicator for applying a fixed volume of processing solution to the surface of the material to be processed, means for moving the applicator and the material relative to each other to enable mixing of the solution on the surface, and means for moving the at least one applicator from a position in contact with the material to a position out of contact with the material such that the process cycle can be varied.

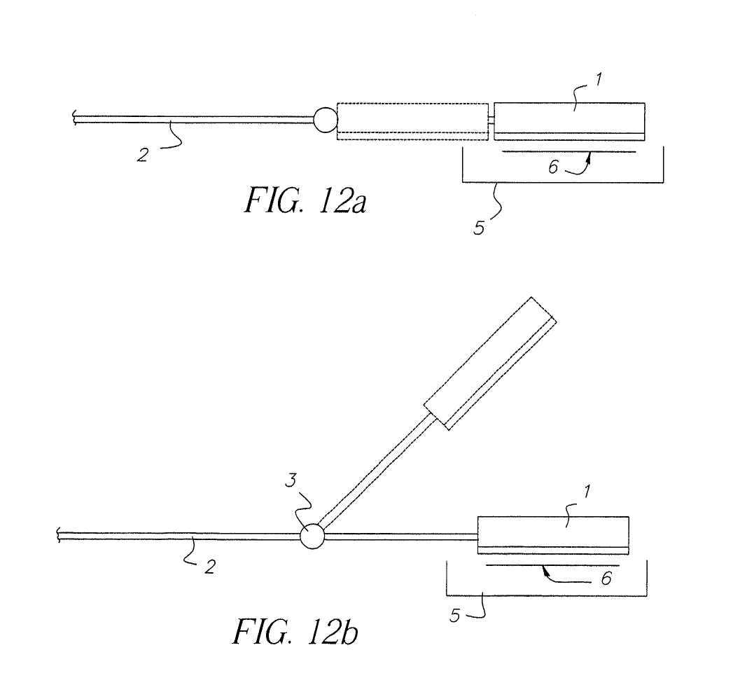

An example of a movable applicator is shown in FIG. 12.

FIG. 12a shows a schematic cross-sectional view of one method of moving the applicator member into and out of contact with the material .

A movable applicator head 1 is positioned in contact with a web of sensitised material 6 to be processed. The material may be film or paper. The applicator head 1 comprises a pad of absorbent material which is enclosed in a shell. The shell may enclose the whole pad with the exception of the front face, which is to contact the sensitised material. The pad may be made of any material which will not cause damage to the sensitised material, for example only, foam, sponge or felt. The shell may be made of a plastics material. In the embodiment illustrated a feed pipe 2 is in connection with the rear of the applicator head. The other end of the feed pipe is connected to a reservoir of processing solution, not shown. It is not essential that the solution is provided to the rear of the applicator head 1. The solution may be supplied to the pad by any suitable means, such as by dipping the pad in a reservoir of the solution. An overflow tray 5 is positioned below the web of material.

In operation, the applicator 1 is brought into contact with the surface of the sensitised material 6. The applicator 1 contacts the surface of the sensitised material across its width. In the embodiment illustrated the processing solution is fed through the feed pipe 2 to the applicator from the reservoir. The applicator 1 supplies a controlled amount of processing solution to the surface of the material 6. The applicator moves backwards and forwards along the length of the material. The processing solutions are thus spread on the surface of the material and mixed so that seasoning effects are distributed in a manner similar to that of a conventional deep tank processor. The processing solution can be supplied either in concentrated single use form or in dilute form. Excess solution is collected in tray 5. The web of material 6 may be either stationary or moving during the process.

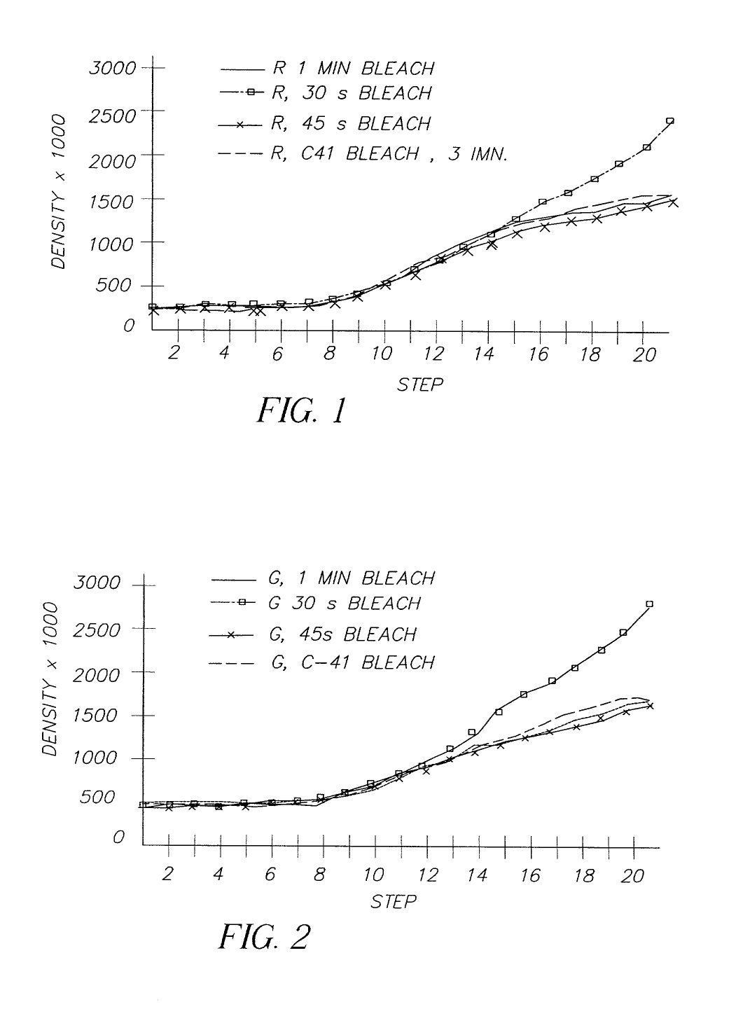

The applicator 1 is moved into and out of contact with the sensitised material 6 as required. In the embodiment shown in FIG. 1a the applicator head is retracted out of contact with material 6 to the position shown by dotted lines. FIG. 12b shows an applicator 1 which is moved out of contact with the material 6 by means of a hinge 3 to position 4, shown by dotted lines. These are just two examples and it will be understood by those skilled in the art that any suitable method of moving the applicator may be utilised.

Applicators 1 can be arranged in rows on either side of the web of material 6 with a separate applicator for each stage of the process. Alternatively there may be more than one applicator for each stage of the process. The solutions may be applied separately or in sequence. It is also envisaged that the same applicator 1 may be used for all the solutions required in the process.

An alternative surface application device is a single use wave processor of the type described in our copending UK Patent Application No. 0023091.2, filed on Sep. 20, 2000 which describes an apparatus for processing a photographic material, comprising a chamber adapted to hold the material therein, means for introducing a metered amount of solution into the chamber, means for removing the solution from the chamber, means for rotating the chamber and means for sweeping the surface of the material at each rotation of the chamber, thereby to form a wave in the solution through which the material may pass.

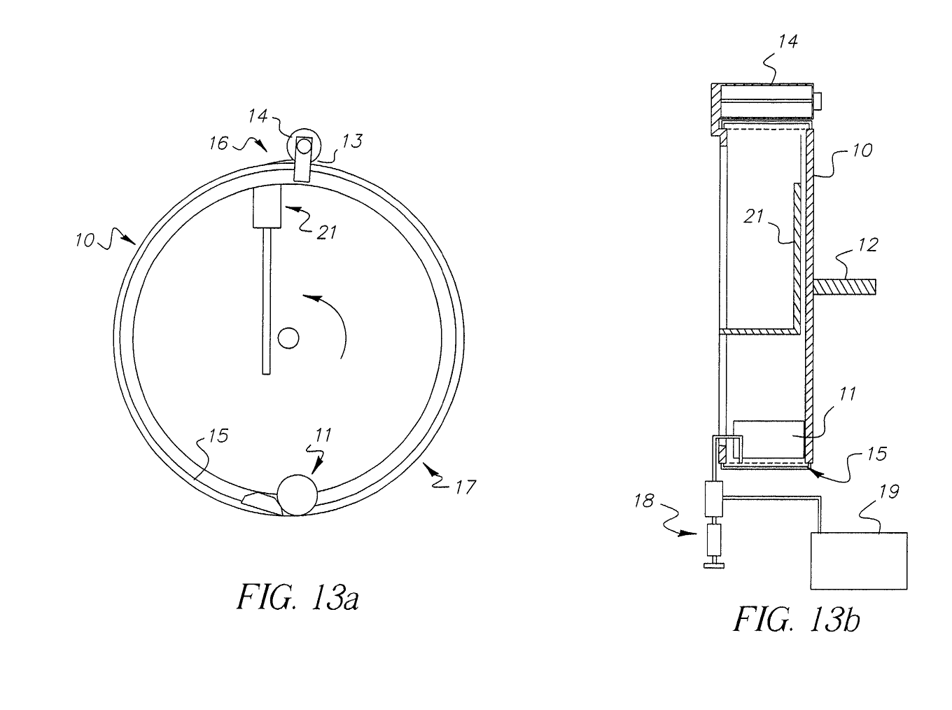

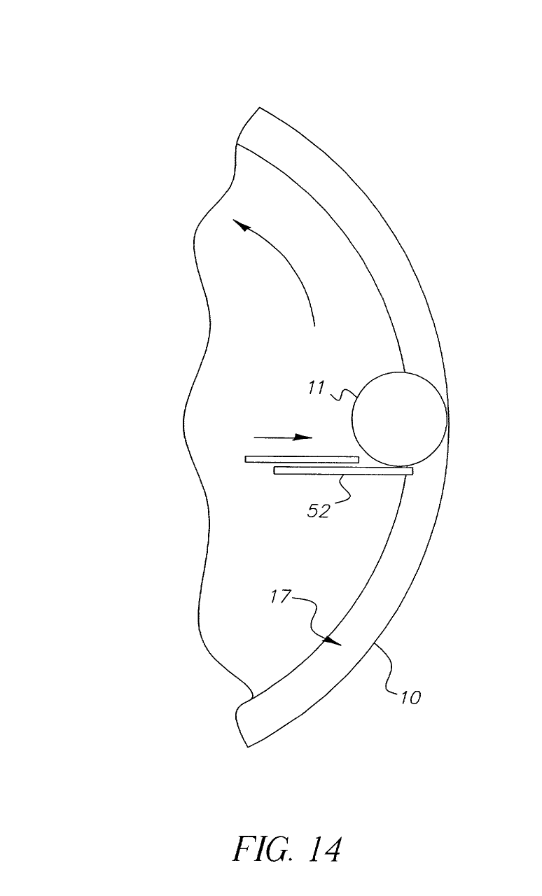

FIGS. 13A and 13B show an embodiment of a wave processor.

The wave processor comprises a cylinder 10 having at least one open end. The cylinder may be made of stainless steel, plastics or any other suitable material. A transparent material, such as polycarbonate, may be used if it is desired to scan the material while it is within the cylinder. The cylinder defines a processing chamber. An arm 13 is provided on the outer side of the cylinder for holding a film cassette 14. A slot 16 with a water tight cover (not shown) is provided through the wall of the cylinder to allow the strip of film 15 from the film cassette to enter the processing chamber. The watertight cover may be in the form of a hinged door having a rubber wedge. However, any suitable means may be used. A circular slot is defined around the inner circumference of the chamber for holding the strip of film 15 by the edges.

A second arm 21 is located within the chamber. This arm 21 grabs the tongue of the film and holds it against the inner circumference of the chamber.

A close fitting cover (not shown) may be provided around the inner circumference of the chamber which sits above the film surface by at least 0.5 mm. This cover provides at least three functions to improve the performance of the apparatus. Firstly it lowers water evaporation which can cause a temperature drop and can concentrate the processing solution as processing is occurring. Secondly it can itself provide agitation by maintaining a puddle of solution in the gap between the cover and the film surface at the lowest point of the chamber. Thirdly it provides a film retaining means making edge guides unnecessary, although edge guides can be also be provided to prevent the film sticking to the cover. It allows both 35 mm film and APS film (24 mm) to be loaded in the same apparatus and it also allows any length of film to be loaded. The material of the cover can be impervious to processing solution and as such is provided with a break or gap in its circumference so that the two extreme ends of the cover do not meet and through which processing solution is added to the film surface. In this embodiment the cover is fixed and rotates with the chamber as the chamber rotates. In another embodiment the cover is not fixed and rests on rails on each side which allow the cover to slide and remain stationary as the chamber rotates. In this embodiment the cover is again provided with a break or gap in its circumference so that processing solutions can be added to the film surface. In this embodiment a roller can also be provided which sits in the gap in the circumference of the cover and which remains essentially at the lowest point of the chamber. The roller provides additional agitation. In another embodiment the cover can be made of a material which is porous to processing solution such as a mesh material or a material punctured with holes. The cover can be made of plastic, metal, or any suitable material. However, the cover is not an essential feature.

A drive shaft 12 is provided at the closed end of the cylinder for rotation thereof. The open end of the cylinder 10 is provided with a flange 17. The flange retains solution within the chamber. In the embodiment shown in FIG. 13B the processing solutions are introduced into and removed from the chamber by means of syringes 18. However any suitable means may be used, for example metering pumps. The solutions may be introduced from a reservoir 19. Alternatively the solutions may be held in a cartridge prior to use. The cartridge can consist of part or all the processing solutions required to complete the process and is easily placed or “plugged in” the processor without the need to open or pour solutions. The cartridge can consist of an assembly of containers for each of the solutions required for the process. The solutions may be removed by suction or any other means. Residue of solutions therefore do not build up within the processing chamber. This results in the processing chamber being essentially self cleaning. The cross over times from one solution to another are very short.

It is possible to mount an infra red sensor outside of the chamber. The sensor monitors the silver density of the material during development thereof. However this is not an essential feature of the invention. A wave forming mechanism is provided within the processing chamber. This wave forming mechanism sweeps the film surface and forms a wave of solution, primarily at the lowest point in the chamber. In the embodiment shown in FIGS. 13A and 13B the mechanism is a free standing roller 11. It is possible that this roller may be held on a loose spindle, (not shown), which would allow the roller to be steered and also to be raised and lowered into position. The position of the roller can be changed with this mechanism so that it is to the left or right of bottom dead centre which can be advantageous for the smooth running of the roller. It is also desirable to raise or lower the roller which might facilitate film loading.

In operation a film cassette 14 is located in the arm 13 and held on the outside of the cylinder 11. The end of the film 15 is withdrawn from the cassette and entered into the processing chamber by means of the slot 16. The arm 21 holds the film against the inner circumference of the cylinder and the cylinder 10 is rotated so that the film 15 is unwound from the cassette and loaded into the processing chamber. The film is held in a circular configuration within the processing chamber. This loading is carried out while the processing chamber is dry although it is also possible to load the film if the chamber is wet. The film is held with the emulsion side facing inwards with respect to the chamber. It is also possible to load the film with the emulsion side facing outwards provided a gap is present between the film surface and the inner circumference of the chamber. Once loaded, the film is held by the edges thereof within the circular slot around the circumference of the chamber.

The processing chamber is heated. The chamber can be heated electrically or by hot air. Alternatively the chamber may be heated by passing the lower end thereof through a heated water bath. The chamber is then rotated. When the desired temperature is reached a given volume of a first processing solution is introduced into the chamber. The processing solution may be heated prior to being introduced into the chamber. Alternatively the solution may be unheated or cooled. As the chamber rotates the film is continuously re-wetted with the given volume of solution.

Processing solution is added onto the roller 1 that is contacted across the whole width thereof by a spreader 52. This can be seen in more detail in FIG. 14. The spreader may be made of flexible soft plastic, rigid plastic or any other suitable material. The roller 11 rotates in contact with the spreader 52. Processing solution is delivered, via a supply pipe, down the spreader to the region of contact between the roller and the spreader. This method forms a uniform bead of solution over the region of contact between the roller and the spreader which extends across the width of the roller 11. This allows uniform spreading of the processing solution onto the film 15 as it passes under the roller 11. It is also possible to add solutions very quickly by “dumping” a given volume into the chamber while it is rotating so that it immediately forms a “puddle” or wave in front of the roller. Yet another method is to add the processing solutions when the chamber is stationary to a region where there is no film or to a region where there is no image such as the fogged end of the film. The rotation of the chamber is then started after the solution has been added. The time interval between adding the solution and starting the rotation can be from zero to any desired hold time.

The roller 11 acts as a wave forming mechanism. This wave forming mechanism, in combination with the rotation of the chamber, provides very high agitation which gives uniform processing even with very active processing solutions. High agitation and mixing are required when only small volumes of solution are being used, in the order of about 0.5 ml. If a large volume of solution is added to the chamber in the absence of a wave forming mechanism a “puddle” of solution is formed and spreading and agitation is achieved. However if a small volume of solution is added to the chamber in the absence of a wave forming mechanism then solution adheres to the film as the chamber rotates. There is no “puddle” formed and there is consequently no agitation or mixing and processing is slow and non-uniform. The agitation and mixing mechanism of the present invention, i.e. the wave forming mechanism, is sufficient to minimise density differences from the front to the back of the film.

The processing solutions i.e. developer, bleach and fix may be added one after the other to the drum which is rotated during each stage. The processing solution of the preceding stage may be removed, conveniently by suction, before the next solution is added. After the wash stage the photographic material, usually film, is removed and the drum dried in preparation for the next photographic material to be processed.

The processing solution of a preceding stage is removed before the processing solution of the next stage is added.

Rapid commercially available bleaches such as Kodak (registered Trade Mark) Flexicolor C-41RA bleach and Kodak Flexicolor C-41 bleach(III) NR are effective in bleaching colour negative films in 45 seconds(Z-131 Manual “Using Kodak (Registered Trade mark) Flexicolor Chemicals” published by Eastman Kodak Company). Konica HQA process in QD-21 minilabs uses a bleach for colour negative film which takes 23.8seconds(Konica Digital Minilab QD-21 system, August 1999). This is the fastest commercial film process at the present time.

Bleaching times using the present invention can be reduced to less than 20 seconds and usually less than 15 seconds while retaining solution stability and process viability.

In the case of a process in which the film or other photographic element is passed through a succession of tanks, the time of an individual process step such as bleaching means the time when the leading edge of the film or other photographic element goes into the first process solution to when the leading edge goes into the second process solution ie it includes the cross over time between tanks.

In the case of surface application process the time of an individual process step means the time from when the first applicator contacts the photographic element to when the second applicator contacts the photographic element.

The invention is illustrated by the following Examples.

A surface application device as shown in FIG. 12 was employed in Examples 1 to 4.

A surface application device as shown in FIGS. 13A, 13B and 14 was employed in Examples 5 and 6

Unless otherwise stated, the bleach composition, the fixer composition, and colour negative film used in the Examples were as follows:

TABLE A
Bleach composition.

| Component | Concentration(g) |
|---|---|
| Acetic acid(glacial) | 196.79 |
| Ammonium bromide(38%) | 64.21 |
| Ammonium hydroxide(28%) | 48.00 |
| PDTA | 28.98 |
| AC3 | 0.73 |
| Ferric nitrate(39%) | 57.32 |
| Water to | 1 litre |

Where ammonium bromide(38%) is 38 g of ammonium bromide in 100 g of aqueous solution, ammonium hydoxide(28%) is 28 g of ammonium hydroxide in 100 g of aqueous solution and ferric nitrate(39%) is 39 g of ferric nitrate in 100 g of aqueous solution.

PDTA is 1,3-propylene diamine tetra acetic acid and AC3 is 2-hydroxy-1,3-propylene diamine tetra acetic acid.

In some of the examples potassium persulfate, sodium persulfate, ammonium persulfate or hydrogen peroxide (30% by weight in water) was added to the bleach composition described above.

In one example the ferric nitrate was left out of the bleach composition and was replaced with 20 g/l of potassium persulfate.

TABLE B
Fixer composition

| Component | Concentration(g) |
|---|---|
| Ammonium thiosulfate(56.5%) | 255.8 |
| EDTA | 1.12 |
| Sodium metabisulfite | 6.44 |
| Acetic acid | 0.55 |
| Water to | 1 litre |

Film Description

The film used in these examples was a full multilayer colour negative film made with bromo-iodide silver halide emulsions containing about 4% iodide. The order of the layers coated on clear film-base was as follows, a metallic silver anti-halation layer containing 355 mg/sq.meter of silver, three red sensitive layers containing a total of about 1393 mg/sq.meter of silver and cyan couplers, an interlayer which scavenges oxidised colour developing agent, three green sensitive layers containing a total of about 1145 mg/sq.meter of silver and magenta couplers, an interlayer which scavenges oxidised colour developing agent and also contains a yellow filter, two blue sensitive layers containing a total of about 1164 mg/sq.meter of silver and yellow couplers and finally a protective gelatin supercoat.

Temperature

The temperature of photographic processing solutions used in continuous processing machines with tanks of a few liters for each stage of the process is normally between 25 to 45 degrees C. If temperatures higher than this are used then evaporation, solution instability and deposit formation occur which prevent any practical use. The present invention can be carried out in an apparatus which uses only a small volume of solution, which is then discarded. This allows the temperature during processing to be higher than in conventional processors for example from about 35 to 60, preferably from about 40 to 55 degrees Centigrade. This gives shorter bleach times.

Processing Solution Stability

The solutions for the film process are preferably used and then discarded and because of this they do not need to be as stable as in conventional methods and this allows them to be more active and achieve shorter bleach times.

Solution Volume

In addition when small volumes are used in the present invention, very unstable bleaches can be made by mixing in the processing tank or in-line just before being added to the processing tank. This means that bleaching times can even shorter.

### EXAMPLE 1

### This is a Comparative Example

The process cycle shown in Table 1 was carried out in a small single use apparatus.

TABLE 1
Process Cycle (50° C.)

| | |
|---|---|
| Develop | 20 seconds |
| Bleach | 30 sec, 45 sec and 1 min |
| Fix | 4 minutes 30 seconds |
| Wash | 2 minutes |

where the bleach was as in Table A.

The acetic acid was necessary to neutralise the high pH of the developer solution.

TABLE 2
D7 Developer

| Component | Amount | |
|---|---|---|
| Demin water | 200 | m |
| KOH(solid) | 8 | g(= 40 g/l) |
| JPSHA(solid) | 2 | g(= 10 g/l) |
| CD4 (solid) | 2 | g(= 10 g/l) |
| Sodium bromide | 12 | g/l |
| TX-100 | 2 | drops |

IPSHA is isopropyl sulphoethylhydroxylamine.

CD4is 4-amino-3-methyl-N-(betahydroxyethyl) aniline sulphate.

TX-100 is a surfactant supplied by Aldrich.

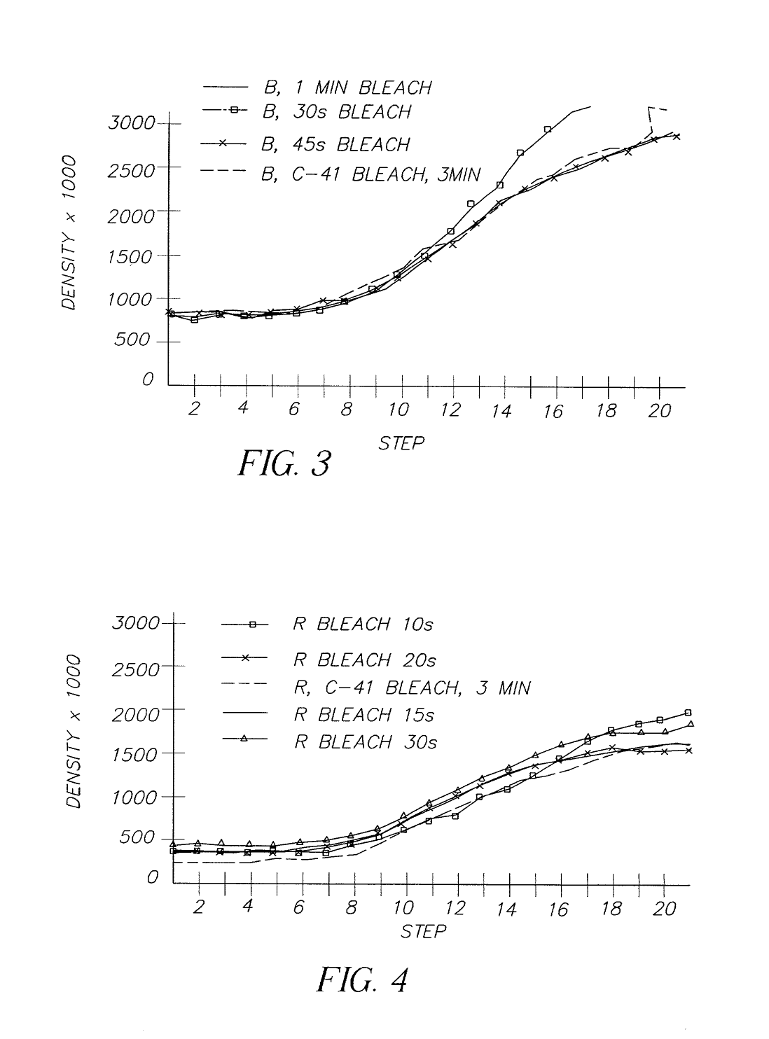

In FIGS. 1, 2 and 3 colour negative film strips were exposed to a 0-4.0 Log E step wedge and processed in the cycle described in Table 1 but were bleached in a 2 liter tank in a standard C-41 process using Bleach III NR for 3 min and fixed in Kodak Flexicolor fix for 4 minutes 30 seconds. This is the reference position and some strips which were bleached with the bleach of Table A for 30, 45 and 60 seconds are also shown. The bleach was applied at 4 ml/linear ft of 35 mm film. It can be seen from FIGS. 1, 2 and 3 that bleaching is complete in all layers at 45 seconds but it is not complete 30 seconds. At 30 seconds the increased dye density in the upper-scale in all colour records is retained silver. This is much less retained silver than in an unbleached strip indicating about 90% of the silver is removed at 30 seconds.It is clear from this example that bleaching is not complete in the upper-scale in 30 seconds but can be achieved in 45 seconds. It is desired however to accelerate bleaching further as examined in the next example.

### EXAMPLE 2

### This is an Example of the Invention

In this example the same process cycle and developer as described in Tables 1 and 2 were used. The bleach was of composition shown in Table A but also included 20 g/l sodium persulphate.

The bleach was applied at 4 ml/linear ft of 35 mm film. Bleaching was carried out for 10, 15, 20 and 30 seconds and the results compared with a standard C-41 process using Bleach III NR for 3 min and fixed in Kodak Flexicolor fix for 4 minutes 30 seconds.

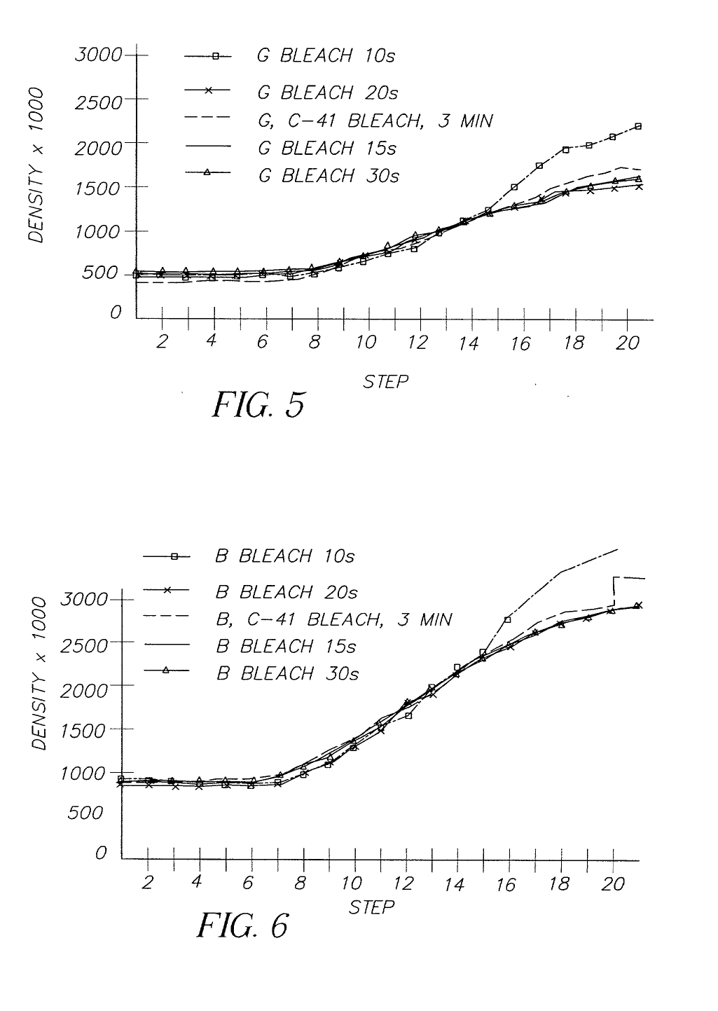

The results are shown in FIGS. 4, 5 and 6 and show that bleaching is not complete in 10 seconds in the upper scale. In 15 seconds or more bleaching is complete.

### EXAMPLE 3

### This is an Example of the Invention

In this example the process cycle shown in Table 3 was used and the composition of the bleach was changed from Example 2 by replacing the sodium persulphate with 20 g/l potassium persulphate.

TABLE 3
Process Cycle (50° C.)

| | |
|---|---|
| Develop | 20 seconds |
| Bleach | 15 seconds |
| Fix | 4 minutes 30 seconds |
| Wash | 2 minutes |

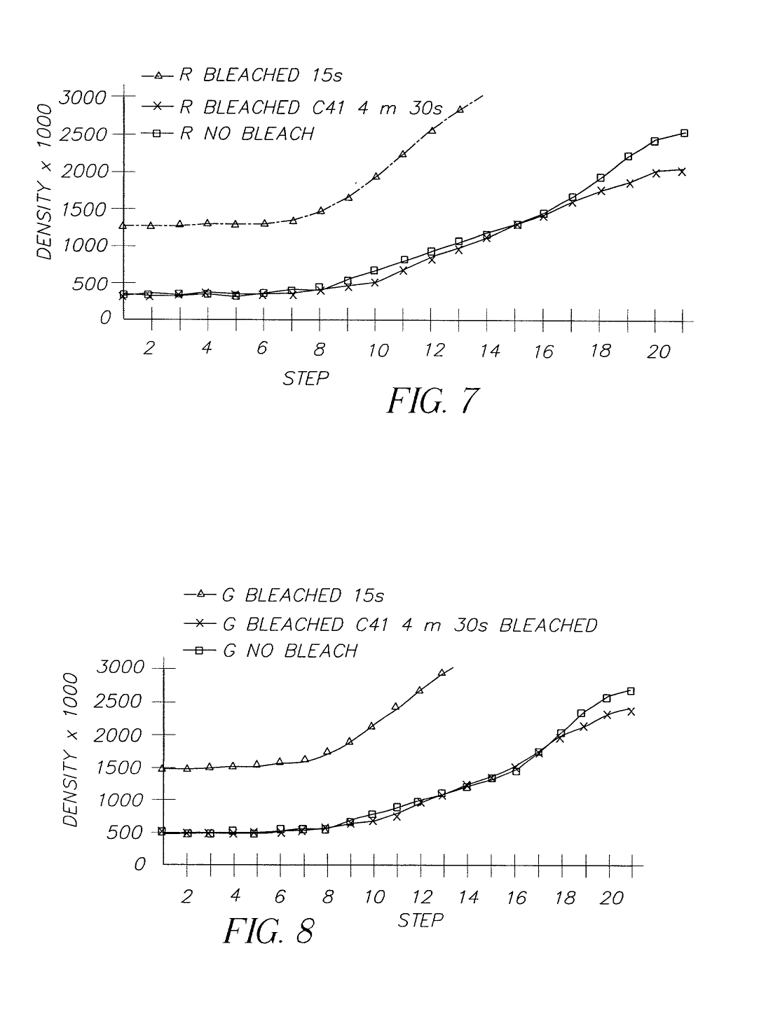

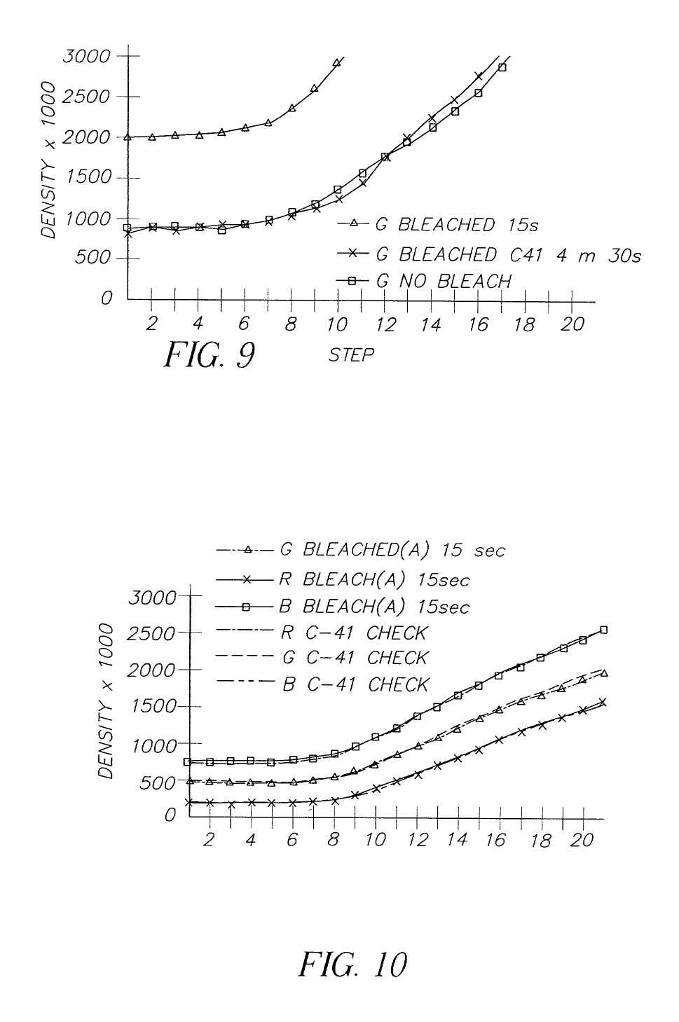

The results were compared with a strip bleached in Kodak Flexicolor Bleach III NR for 4 minutes 30 seconds and also with an unbleached strip. The bleach was applied at 2 ml/linear ft of 35 mm film. The results are shown in FIGS. 7, 8 and 9.

It can be seen from these Figs that the rapid bleach (15 seconds) is almost equivalent to the C-41 bleach. The reatained silver in the unbleached sample generated a much higher density in all colour records. Thus this Example demonstrates that a very rapid bleach is possible using the invention. It has also been found that similar results are obtained if the equivalent amounts of potassium or ammonium persulphate are used in place of the sodium persulphate.

### EXAMPLE 4

### This is an Example of the Invention

In this example another secondary oxidant is used to accelerate silver bleaching. In this case hydrogen peroxide was used.

The process cycle shown in Table 4 was used. The developer used is shown in Table 5. The rapid bleach was the bleach of Table A incorporating various levels of hydrogen peroxide(30%) as shown in Table 6. The bleach was applied at 2 ml/linear ft of 35 mm film.

TABLE 4
Process Cycle (50° C.)

| | |
|---|---|
| Develop | 15 seconds |
| Bleach | 15 seconds |
| Fix | 4 minutes 30 seconds |
| Wash | 2 minutes |

TABLE 5
Developer Composition

| Component | Concentration | |
|---|---|---|
| Na₃PO₄ 12H₂O | 50 | g/l |
| IPSHA | 10 | g/l |
| CD4 | 10 | g/l |
| KOH | 11.5 | g/l |
| Tween 80 | 10 | drops/l |

Table 6 shows the results of Dmax measurements for the standard C-41 bleached strips (4 minutes 30 seconds) compared with the rapid bleach (15 seconds) using hydrogen peroxide.

TABLE 6
Effect of hydrogen peroxide on silver bleaching

Dmax

| Bleach | Red | Green | Blue |
|---|---|---|---|
| Unbleached | 2.51 | 3.43 | 5.51 |
| C-41 | 0.92 | 1.48 | 3.31 |
| Peroxide 20 ml/l | 1.13 | 2.08 | 3.85 |
| Peroxide 40 ml/l | 0.85 | 1.56 | 3.44 |

It can be seen that with 40 ml/l of hydrogen peroxide silver bleaching is complete.

It has been observed that with higher levels of secondary oxidants that a pink stain can occur. This is due to oxidation of the colour developing agent by the active bleach. This can be eliminated by use of a short stop bath(5 seconds) consisting of 5% acetic acid in between the developer stage and the bleach stage.

### EXAMPLE 5

### This is an Example of the Invention.

In this example another type of surface application processor was used. In this processor small volumes of processing solution are added and removed in sequence from the processor. The film used was a colour negative film and was the same as that used in the previous examples. The film samples were exposed to a graduated 21 step tablet with 0.2 density increments per step with an overall exposure range of 0 to 4.0 log exposure units. These strips were pre-developed in Kodak Flexicolor C-41 developer for the standard development time of 3 minutes 15 seconds, they were then stopped for 1 minute in 5% acetic acid. The strips were then washed and dried. These strips still had retained silver and were subsequently used for bleaching experiments described below.

The process cycle used was as follows;

TABLE 7
Process cycle
Pre-developed strip as described above

| | |
|---|---|
| Bleach of Table 8 | 15 seconds, used at 4 ml/linear foot(13.2 ml/meter) of |
| | 35 mm film, 48° C. |
| Fix | 40 seconds, used at 4 ml/linearfoot(13.2 ml/meter) of |
| | 35 mm film, 48° C. |
| Wash | 2 minutes. |

Where the bleach formula was as follows;

TABLE 8
Bleach Formula hereafter referred to as bleach A (invention)

| | | |
|---|---|---|
| Acetic acid(glacial) | 76.8 | g/l |
| NH₄Br | 24.4 | g/l |
| Animonia(880) | 13.4 | g/l |
| PDTA | 28.98 | g/l |
| AC3 | 0.73 | g/l |
| Ferric nitrate(39%0 | 57.32 | g/l |
| Na₂S₂O₈ | 20 | g/l |

where PDTA is 1,3-propylenediamine tetra acetic acid, AC3 is 2-hydroxy-1,3-propylenediamine tetra acetic acid.

This bleach formula has less acetic acid than that used in examples 1 to 4, which had an extra 120 ml/l of glacial acetic acid to neutralise the high pH developer used in the preceding stage of the process cycle. The strips in the present example were pre-developed, stopped, washed and dried and did not need the extra acetic acid because no neutralisation was required. The final bleach pH, about 4, is the same in both cases. The bleach above has both a primary oxidant, ferric PDTA, and a secondary oxidant sodium persulfate.

The fix was Kodak Flexicolor C-41b fixer.

The result is shown in FIG. 10 which is compared with the same pre-developed strips but now bleached and fixed in the standard C-41 Flexicolor process; these are the reference strips which indicate when the film is properly bleached. It can be seen that in comparison with the standard reference process the very rapid bleach of the invention gives very similar results.

### EXAMPLE 6

### This is an Example of the Invention

The same surface application processor as used in example 5 was used. In addition the same pre-developed strips as used in example 5 were used. A comparative bleach solution was made in which the primary oxidant, ferric PDTA, was omitted but the secondary oxidant, sodium persulfate was present. This is shown in table 9.

TABLE 9
Comparative bleach (hereafter referred to as bleach B)

| | | |
|---|---|---|
| Acetic acid (glacial) | 76.8 | g/l |
| NH₄Br | 24.4 | g/l |
| Ammonia (880) | 13.4 | g/l |
| PDTA | 28.98 | g/l |
| AC3 | 0.73 | g/l |
| Na₂S₂O₈ | 20 | g/l |

Another bleach was mad but without the extra acetic acid for the reason explained above. This has the composition shown in table 10 below.

TABLE 10
Bleach Formula (existing prior art, hereafter referred
to as bleach C)

| | | |
|---|---|---|
| Acetic acid (glacial) | 76.8 | g/l |
| NH₄Br | 24.4 | g/l |
| Ammonia (880) | 13.4 | g/l |
| PDTA | 28.98 | g/l |
| AC3 | 0.73 | g/l |
| Ferric nitrate (39%) | 57.32 | g/l |

In this bleach, only the primary oxidant, ferric PDTA, is present.

The process cycle used was as follows;

TABLE 11
Process cycle
Pre-developed strip.

| | |
|---|---|
| Bleach (A, B or C) | range from; 15 seconds to 2 minutes |
| Fix | 40 seconds |
| wash | 2 minutes |

bleach and fix used at 4 ml/linear foot (13.2 ml/lineaar meter) of 35 mm film at 48° C.
where Fix is Kodak Flexicolor Fixer C-41b.

The results are shown in Table 12 compared with unbleached strips in which all the silver was retained. The retained silver shows as a higher density in all the three colour records.

TABLE 12
Densities at Step 13 and 18

| | | Density step 13 | | | Density step 18 | | |
|---|---|---|---|---|---|---|---|
| Bleach | Time | R | G | B | R | G | B |
| A | 15 sec | 0.71 | 1.13 | 1.51 | 1.27 | 1.69 | 2.20 |
| B | 15 sec | 1.97 | 2.46 | 3.00 | 2.96 | >3.0 | >3.0 |
| B | 60 sec | 1.91 | 2.42 | 2.97 | 2.91 | >3.0 | >3. |
| B | 120 sec | 1.83 | 2.34 | 2.91 | 2.82 | >3.0 | >3.0 |
| C | 15 sec | 0.53 | 1.23 | 1.83 | 1.38 | 2.23 | 2.81 |
| C | 45 sec | 0.79 | 1.22 | 1.60 | 1.44 | 1.83 | 2.34 |

| | | | | | | |
|---|---|---|---|---|---|---|
| C-41 reference3 min, | 0.71 | 1.15 | 1.50 | 1.27 | 1.72 | 2.20 |
| 37.8° C. | | | | | | |
| unbleached strip | 1.97 | 2.47 | 3.02 | 2.91 | >3.0 | >3.0 |

It is clear from the data in table 12 that bleach A of the invention bleaches the silver in 15 seconds and gives densities very close to those of the C-41 reference strip. If the primary oxidant is omitted as in bleach B then silver bleaching does not occur in 15 seconds, 60 seconds or even 120 seconds. This can be seen by comparing the densities at step 13 for bleach B which are almost the same as those for the unbleached strip. Thus the secondary oxidant does not act as a bleach in its own right in this formulation.

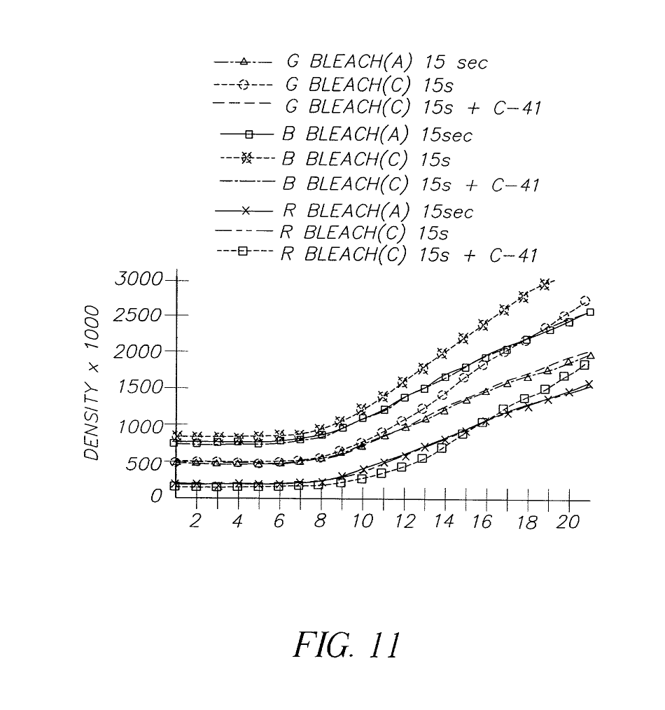

Furthermore if only the primary oxidant is used as in bleach C then at 15 seconds two problems arise. The first problem is that bleaching is not complete in the blue layer in 15 seconds and second problem is that the red density is low (0.53 compared with the aim of 0.71) which indicates a “leuco cyan dye” problem. This is caused by the cyan dye not being fully oxidised from the colourless leuco dye intermediate into the cyan dye. This is shown more fully in FIG. 11 in which bleach A for 15 seconds is compared with bleach C for 15 seconds and also with bleach C for 15 seconds then re-bleached in the C-41 process. It can be seen from FIG. 11 that bleach C at 15 seconds has a severe “leuco cyan dye” problem indicated by the low red density particularly in the toe of the curve. It is also clear that in the upper-scale the higher densities indicate that bleach C in 15 seconds does not fully bleach all the silver. If the strips from bleach C at 15 seconds are now re-bleached in the C-41 reference process then the “leuco cyan dye” problem is removed as indicated by the increase in red density particularly in the toe of the curve and bleaching is now complete in the upper-scale. It is particularly significant that the bleach C strips re-bleached in the C-41 reference process are now a very good match for the bleach A strips bleached for 15 seconds without further treatment. Thus it is clear that bleach A of the invention solves two problems associated with existing art bleaches; firstly bleaching is complete in 15 seconds even in the upper-scale region and secondly the “leuco cyan dye” problem is eliminated.

It has been shown that the conventional bleach which uses the primary oxidant does bleach silver but it is slow and has a “leuco cyan dye” problem. The bleach that contains both the primary oxidant and the secondary oxidant bleaches silver very rapidly in 15 seconds and does not have a “leuco cyan dye” problem. However if the primary oxidant is not present and only the secondary oxidant is present the bleach is not effective even after two minutes. Thus the bleach of the invention has an unexpected synergy in that the combination of two oxidants results in a bleach which is faster than the sum of the rates of the two oxidants used separately and the combination of two oxidants also removes a “leuco cyan dye” problem associated with short bleach times.

1. An aqueous photographic bleach solution comprising,
as primary oxidant, a transition metal oxidizing agent in a concentration of at least about 0.1 Molar and,
as secondary oxidant, a persulphate in a concentration of at least about 0.03 Molar or peroxide in a concentration of at least about 0.1 Molar.

2. An aqueous photographic bleach solution as claimed in claim 1 wherein the primary oxidant is a ferric complex of an aminopolycarboxylic acid.

3. An aqueous photographic bleach solution as claimed in claim 2 wherein the aminopolycarboxylic acid is ethylene diamine tetraacetic acid (EDTA), propylene diamine tetraacetic acid (PDTA), diethylene triamine pentaacetic acid (DTPA), or a substituted imino diacetic acid such as methyl imino diacetic acid (MIDA).

4. An aqueous photographic bleach solution as claimed in claim 1 which further includes an effective amount of a rehalogenating agent.

5. An aqueous photographic bleach solution as claimed in claim 1 that further includes a buffering agent.

6. An aqueous photographic bleach solution as claimed in claim 1 wherein the secondary oxidant is provided by peroxide and the amount of peroxide in the solution is at least equivalent to that provided by 30 ml/liter of hydrogen peroxide as a 30% by weight solution.

7. A photographic bleaching process which comprises bleaching a silver halide photographic element which has been exposed and developed by contacting said exposed and developed photographic element with a bleach solution comprising, as primary oxidant, a transition metal oxidizing agent in a concentration of at least about 0.1 Molar and, as secondary oxidant, a persulphate in a concentration of at least about 0.03 Molar or peroxide in a concentration of at least about 0.1 Molar.

8. A photographic bleaching process as claimed in claim 7 wherein the bleaching is carried out employing a single use surface application process.

9. A photographic bleaching process as claimed in claim 8 wherein the photographic element is contacted with the bleach solution in a tank of generally cylindrical shape and, to facilitate bleaching, the tank is rotated about the axis of the cylinder.

10. A photographic bleaching process as claimed in claim 7 for the bleaching of 35 mm film wherein the application rate is at least 0.5 ml of bleach solution per linear foot of 35 mm film, preferably from 1 to 6 ml/linear foot of film.

11. A photographic process as claimed in claim 7 wherein the photographic material after development but before bleaching is contacted with a stop solution to lower the pH to prevent stain formation when contacted with the bleaching solution.

12. A photographic process as claimed in claim 7 wherein the bleaching is followed by a fixing step to remove oxidized silver.
